(19) United States
(12) Patent Application Publication
(10) Pub. No.: US 2025/0309756 A1
(43) Pub. Date: Oct. 2, 2025

(54) DEVICE FOR CONTROLLING THE PRECHARGE OF A BULK CAPACITOR AND FOR DETECTING FAULTS IN A DC CURRENT CIRCUIT

(71) Applicant: STMicroelectronics International N.V., Geneva (CH)

(72) Inventor: Ghafour BENABDELAZIZ, Tours (FR)

(21) Appl. No.: 19/080,307

(22) Filed: Mar. 14, 2025

(30) Foreign Application Priority Data
Mar. 29, 2024 (FR) FR2403255

(51) Int. Cl. H02M 1/42; H02J 7/34; H02M 7/04; H02M 7/162

(52) U.S. Cl. CPC H02M 1/4283; H02J 7/345; H02M 7/05; H02M 7/1623

(57) ABSTRACT

The present description concerns a device for controlling the precharge of a bulk capacitor and for detecting faults in a DC current circuit which comprises the bulk capacitor, at least one DC voltage source, and at least a first precharge switch coupled to an electrode of the bulk capacitor The device comprises at least a pulse transformer provided with a primary and with at least a first and a second secondaries and a circuit for controlling the precharge of the bulk capacitor, coupled to the primary of the pulse transformer. The first secondary of the pulse transformer comprises a first terminal configured to be coupled to a control input of the first precharge switch. The second secondary of the pulse transformer is configured to be coupled in parallel with the bulk capacitor.

### CROSS REFERENCE TO RELATED APPLICATIONS

This application claims the priority benefit of French Patent Application Number 24/03255, filed on Mar. 29, 2024, entitled “Dispositif de commande de précharge d'une capacitéde stockage et de détection de défaut dans un circuit àcourant continu”, which is hereby incorporated by reference to the maximum extent allowable by law.

### TECHNICAL FIELD

The present disclosure generally concerns the field of DC current electrical circuits.

### BACKGROUND

In a DC current electrical circuit, a bus comprising at least two electrically-conductive elements is coupled on the one hand to a DC voltage source corresponding for example to a battery or to the output of a DC/DC or AC/DC converter, and on the other hand to components of the circuits including capacitive elements which can be generally assimilated to a bulk capacitor. This bulk capacitor is coupled in parallel with the DC voltage source by the conductive elements of the bus and by at least a switch enabling to couple or to decouple the DC voltage source to or from the bus.

When the switch is turned on, or closed, to couple the bus to the DC voltage source, a significant inrush current flows between the DC voltage source and the bulk capacitor. To avoid the occurrence of this inrush current, the bulk capacitor may be precharged by conducting a precharge current through the bulk capacitor before the turning-on of the switch. This precharge phase is implemented for a time period sufficient to obtain, across the bulk capacitor, the desired precharge voltage.

However, during this precharge phase of the bulk capacitor, if a fault is present over the bus, such as for example a short-circuit or a significant current leakage, a very high current may circulate in the bus and damage the other elements of the circuit coupled to the bus.

When a thyristor is used as a switch to couple the DC voltage source to the bus during the precharge of the bulk capacitor, in case of a fault present on the circuit, it is not possible to turn off this thyristor due to the fact that the current that it conducts is then very high. A turning-off of the thyristor enabling to stop the circulation of this high current requires using an additional circuit dedicated to this function.

When an electromechanical relay is used as a switch to couple the DC voltage source to the bus during the precharge of the bulk capacitor, it is possible to detect a short-circuit of the bulk capacitor. However, this detection is only possible when the relay is closed, which leaves, before this detection, a certain time period during which the current which circulates may damage elements of the circuit. Further, the delay of opening of an electromechanical relay is long and increases along time.

### BRIEF SUMMARY

There exists a need to provide a solution enabling to detect the presence or not of a fault in a DC current circuit before performing a precharge of a bulk capacitor of the circuit in the absence of such a fault.

An embodiment overcomes all or part of the disadvantages of known solutions and provides a device for controlling the precharge of a bulk capacitor and for detecting faults in a DC current circuit which comprises the bulk capacitor, at least one DC voltage source, and at least a first precharge switch coupled to an electrode of the bulk capacitor, the device comprising at least: a pulse transformer provided with a primary and with at least a first and a second secondaries; and a circuit for controlling the precharge of the bulk capacitor, coupled to the primary of the pulse transformer. The first secondary of the pulse transformer comprises a first terminal configured to be coupled to a control input of the first precharge switch, and wherein the second secondary of the pulse transformer is configured to be coupled in parallel with the bulk capacitor.

In a particular embodiment, the device further comprises at least a first power storage capacitor coupled in parallel with the first secondary of the pulse transformer.

In a particular embodiment, the device further comprises at least a first voltage rectifier diode having its anode coupled to the first terminal of the first secondary of the pulse transformer, and/or at least a first electric current limiting resistor having an electrode configured to be coupled to the control input of the first precharge switch.

In a particular embodiment, the device further comprises at least a second Zener diode having its cathode coupled to the cathode of the first voltage rectifier diode and having its anode configured to be coupled to the control input of the first precharge switch.

In a particular embodiment, the device further comprises at least a second protection diode coupled in series with the second secondary of the pulse transformer.

In a particular embodiment, the circuit for controlling the precharge of the bulk capacitor comprises at least: a third diode having its cathode coupled to a first terminal of the primary of the pulse transformer; a first Zener diode having its anode coupled to the anode of the third diode and having its cathode coupled to a second terminal of the primary of the pulse transformer; and a control switch coupled to the second terminal of the primary of the pulse transformer.

In a particular embodiment, a second terminal of the first secondary of the pulse transformer is coupled to one of the terminals of the second secondary of the pulse transformer.

In a particular embodiment, the pulse transformer comprises at least a third secondary having its terminals configured to be coupled to a voltage measurement device or to a control input of a second precharge switch.

Another embodiment provides a DC current circuit comprising at least: a DC voltage source; a bus comprising at least two conductive elements, each coupled to one of the terminals of the DC voltage source; a capacitive element forming a bulk capacitor having each of its electrodes coupled to one of the two conductive elements of the bus; a first precharge switch coupled to an electrode of the bulk capacitor; and a device for controlling the precharge of the bulk capacitor and for detecting faults in the DC current circuit according to a particular embodiment.

In a particular embodiment, the DC voltage source comprises at least a battery.

In a particular embodiment, the first precharge switch comprises at least a first thyristor and the control input of the first precharge switch corresponds to the gate of the first thyristor, and the circuit further comprises at least: a second electric current limiting resistor series-coupled to the first thyristor; and first and second cut-off switches, each coupled between one of the terminals of the DC voltage source and one of the electrodes of the bulk capacitor, at least one of the first and second cut-off switches comprising a relay.

In a particular embodiment, one of the first and second cut-off switches is coupled in parallel with the first thyristor and with the second electric current limiting resistor.

In a particular embodiment: the DC voltage source comprises an AC/DC voltage converter of totem pole type comprising at least two conversion transistors and at least two conversion thyristors having their gates each coupled to a third electric current limiting resistor and an optocoupler series-coupled to each other and forming first and second precharge switches; the pulse transformer of the device comprises at least a third secondary; the first terminal of the first secondary of the pulse transformer of the device is coupled to an input electrode of one of the optocouplers; and a first terminal of the third secondary of the pulse transformer of the device is coupled to an input electrode of the other one of the optocouplers.

In a particular embodiment: the DC voltage source comprises an AC/DC voltage converter of Boost PFC type with a mixed bridge comprising at least two conversion diodes and at least two conversion thyristors, or at least four conversion thyristors, having their gates each coupled to a third electric current limiting resistor and an optocoupler series-coupled to each other and forming first and second precharge switches; and the first terminal of the first secondary of the pulse transformer of the device is coupled to an input electrode of each of the optocouplers.

In a particular embodiment: the DC voltage source comprises an AC/DC voltage converter of Boost PFC type with a diode bridge; and the first precharge switch comprises at least a first thyristor, a third electric current limiting resistor, and an optocoupler series-coupled to each other.

Another embodiment proposes a method for controlling the precharge of a bulk capacitor and for detecting faults in a DC current circuit which comprises the bulk capacitor, at least one DC voltage source, and at least a first precharge switch coupled to an electrode of the bulk capacitor. The method uses a pulse transformer provided with a primary and with at least a first and a second secondaries, and also a circuit for controlling the precharge of the bulk capacitor, coupled to the primary of the pulse transformer. In this method, the first secondary comprises a first terminal coupled to a control input of the first precharge switch, and the second secondary is coupled in parallel with the bulk capacitor.

In a particular embodiment, the method comprises sending a control signal, through the circuit for controlling the precharge of the bulk capacitor, to the primary of the pulse transformer. In the absence of a fault in the DC circuit, the method involves generating voltages at the terminals of the first and second secondaries, and sending a current to the control input of the first precharge switch that triggers the precharge of the bulk capacitor. In the presence of a fault in the DC circuit, the method involves maintaining zero or very low voltage at the terminals of the first and second secondary terminals, and keeping the first precharge switch in a blocked state preventing pre-charge of the storage capacity.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 schematically shows an example of implementation of a device for controlling the precharge of a bulk capacitor and for detecting faults in a DC current circuit;

FIG. 2 schematically shows a device for controlling the precharge of a bulk capacitor and for detecting faults in a DC current circuit according to a first embodiment;

FIG. 3 shows a simplified timing diagram of signals obtained within the device for controlling the precharge of a bulk capacitor and for detecting faults in a DC current circuit according to the first embodiment, in the absence of a fault in the circuit;

FIG. 4 shows a simplified timing diagram of signals obtained within the device for controlling the precharge of a bulk capacitor and for detecting faults in a DC current circuit according to the first embodiment, in the presence of a fault in the circuit;

FIG. 5 schematically shows a device for controlling the precharge of a bulk capacitor and for detecting faults in a DC current circuit according to a first variant of the first embodiment;

FIG. 6 schematically shows a device for controlling the precharge of a bulk capacitor and for detecting faults in a DC current circuit according to a second variant of the first embodiment;

FIG. 7 schematically shows a device for controlling the precharge of a bulk capacitor and for detecting faults in a DC current circuit according to a second embodiment;

FIG. 8 schematically shows a device for controlling the precharge of a bulk capacitor and for detecting faults in a DC current circuit according to a third embodiment; and

FIG. 9 schematically shows a device for controlling the precharge of a bulk capacitor and for detecting faults in a DC current circuit according to a fourth embodiment.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, different elements (voltage source, bus, switches, control circuit, transformer, etc.) of the device for controlling the precharge of a bulk capacitor and of fault detection in a DC current circuit are not described in detail. Those skilled in the art will be capable of implementing in detailed fashion these elements based on the functional description given herein.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

Unless indicated otherwise, the term “conductive” is used to designate an electric conduction.

All throughout the document, the term “fault” used in connection with the DC current circuit designates an electric fault present in the circuit, for example a short-circuit of the bulk capacitor or a significant current leakage.

Unless specified otherwise, the expressions “about”, “approximately”, “substantially”, and “in the order of” signify plus or minus 10%, preferably of plus or minus 5%.

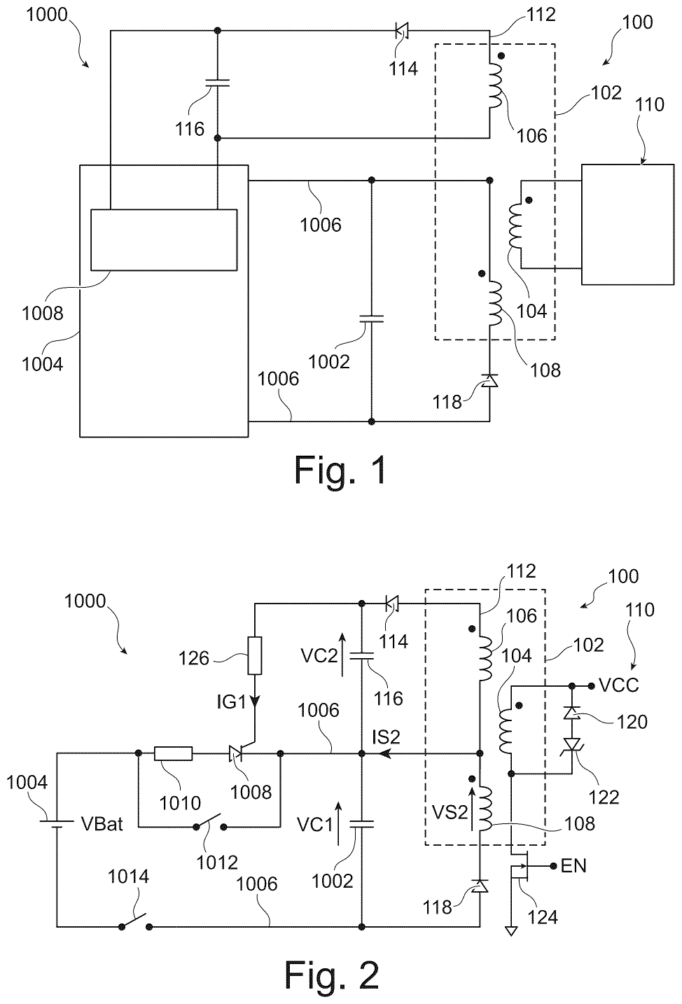

An example of embodiment of a device 100 for controlling the precharge of a bulk capacitor 1002 and for detecting faults in a DC current circuit 1000 having bulk capacitor 1002 located therein is described hereafter in relation with FIG. 1.

Circuit 1000 comprises at least one DC voltage source 1004 comprising for example one or a plurality of batteries and/or at least one DC/DC or AC/DC converter. Other types of DC voltage sources may however be included in circuit 1000.

Circuit 1000 further comprises a bus intended for the circulation of a DC current in circuit 1000 and comprising at least two conductive elements 1006, each coupled to one of the terminals of source 1004. In the described example of embodiment, source 1004 is intended to apply to these conductive elements 1006 a DC electric voltage and to deliver a DC current circulating through the conductive elements 1006 of the bus.

Circuit 1000 further comprises other electric components coupled to the bus and forming one or a plurality of capacitive electric elements which will be generally assimilated to bulk capacitor 1002. Each of the electrodes of bulk capacitor 1002 is coupled to one of the two conductive elements 1006 of the bus of circuit 1000.

Circuit 1000 further comprises at least one precharge switch 1008 coupled to one of the electrodes of bulk capacitor 1002. In the example of FIG. 1, precharge switch 1008 is included in source 1004. As a variant, precharge switch 1008 may be an element distinct from source 1004. Precharge switch 1008 may be coupled between a first terminal of source 1004 and one of the electrodes of bulk capacitor 1002.

Circuit 1000 further comprises device 100 for controlling the precharge of bulk capacitor 1002 and for detecting faults in circuit 1000.

Device 100 comprises at least one pulse transformer 102 provided with a primary 104 and with at least one first secondary 106 and one second secondary 108, primary 104 being magnetically coupled to the first and second secondaries 106, 108. The first and second secondaries 106, 108 may be similar or not to each other, in terms of number of windings. The electric characteristics of transformer 102 may be selected in particular according to the voltage and current levels to which the elements of transformer 102 are intended to be submitted.

Device 100 further comprises a circuit 110 for controlling the precharge of bulk capacitor 1002, which is coupled to primary 104. In the described example of embodiment, circuit 110 is intended to apply a voltage in the form of pulses across primary 104 during a precharge of bulk capacitor 1002.

First secondary 106 comprises a first terminal 112 coupled to a control input of precharge switch 1008. In the example of FIG. 1, the first terminal 112 of first secondary 106 is coupled to the control input of precharge switch 1008 via a voltage rectifier diode 114 comprising its anode coupled to the first terminal 112 and its cathode coupled to the control input of precharge switch 1008.

In the described example of embodiment, device 100 further comprises a power storage capacitor 116 coupled in parallel with first secondary 106 and intended to form a power supply to control the precharge switch 1008. In the example of FIG. 1, the first terminal 112 of the first secondary 106 is coupled to one of the electrodes of the power storage capacitor 116 via the voltage rectifier diode 114, the power storage capacitor 116 being here coupled in parallel with the assembly formed by the first secondary 106 and the voltage rectifier diode 114. In the example of FIG. 1, the cathode of the voltage rectifier diode 114 is coupled to one of the electrodes of the power storage capacitor 116 and the anode of the voltage rectifier diode 114 is coupled to the first terminal 112 of the first secondary 106. Given the voltage variations across the first secondary 106, the voltage rectifier diode 114 enables the power storage capacitor 116 to be charged with a constant DC voltage when the voltage across the first secondary 106 is positive.

The second secondary 108 is coupled in parallel with bulk capacitor 1002. In the example of FIG. 1, device 100 further comprises a protection diode 118 coupled in series to the second secondary 108 and prevents the bulk capacitor 1002 from discharging through the second secondary 108 when the bulk capacitor 1002 is precharged, while allowing current to flow between the bulk capacitor 1002 and the second secondary 108 during the fault presence check phase. In a specific configuration corresponding to that shown in FIG. 1, the cathode of the protection diode 118 is coupled to one of the terminals of the second secondary 108 and the anode of the protection diode 118 is coupled to one of the electrodes of bulk capacitor 1002. In the example of FIG. 1, bulk capacitor 1002 is coupled in parallel with the assembly formed by the second secondary 108 and the protection diode 118.

In this circuit 1000 comprising device 100, when bulk capacitor 1002 is intended to be precharged, for example before a connection of source 1004 to the bus, circuit 110 controls transformer 102 in such a way that a voltage in the form of non-zero pulses is applied across primary 104. In the absence of a fault, particularly in the absence of a short-circuit across bulk capacitor 1002, a first voltage in the form of non-zero pulses is generated across the first secondary 106 and a second voltage in the form of non-zero pulses is generated across the second secondary 108. The second voltage across the second secondary 108 charges the bulk capacitor 1002, for example by a few volts, and at the same time the first voltage present across the first secondary 106 generates a current circulating through the power storage capacitor 116 and thus increasing the potential difference across the power storage capacitor 116. This potential difference across the power storage capacitor 116 generates the sending of a control current onto the control input of precharge switch 1008, which then triggers the precharge of bulk capacitor 1002 when precharge switch 1008 turns on.

However, in the presence of a fault such as a short-circuit across bulk capacitor 1002, the voltage across second secondary 108 remains equal to zero despite the voltage applied by circuit 110 to primary 104. The voltage across the first secondary 106 thus also remains equal to zero. Thus, no current flows to charge the power storage capacitor 116, and thus no control current is sent to the control input of precharge switch 1008. The precharge of bulk capacitor 1002 is thus not triggered due to the fact that precharge switch 1008 remains in the off state.

Thus, transformer 102 simultaneously fulfills two functions: the first secondary 106 is used to control the conduction state of precharge switch 1008 according to the presence or not of a fault in circuit 1000, and the second secondary 108 is used to detect the presence or not of a fault in circuit 1000.

An example of the device 100 and of the circuit 1000 according to a first embodiment is described hereabove in relation with FIG. 2. In this first embodiment, circuit 1000 may form part of or form a system for controlling a vehicle battery.

In the first embodiment, source 1004 comprises one or a plurality of batteries delivering a DC voltage VBat. For example, the battery or the batteries of source 1004 may correspond to that or those of an electric vehicle, where the voltage delivered across source 1004 may be equal to approximately 400 V or 800 V or another value.

In the example of FIG. 2, circuit 110 comprises at least: a diode 120 having its cathode coupled to a first terminal of primary 104; a Zener diode 122 having its anode coupled to the anode of diode 120 and having its cathode coupled to a second terminal of primary 104; and a control switch 124 configured to control the voltage pulses applied across primary 104.

Diodes 120, 122 form a demagnetizing circuit for transformer 102. In a first phase, the control switch 124 is closed and current flows through the primary 104. When the primary 104 is blocked by opening control switch 124, the power stored in the transformer 102 must be drained off. An overvoltage then arises at the terminal of the control switch 124 coupled to the primary 104. The Zener diode 122 is used to clip this overvoltage and protect the primary 104. The diode 120 allows current to flow between the Zener diode 122, the diode 120 and the primary 104 during this phase.

In the example of FIG. 2, control switch 124 comprises a MOSFET-type transistor. One of the source or drain electrodes of this transistor may be coupled to the second terminal of primary 104 and the other source or drain electrode of this transistor may be coupled to a reference electric potential. In the example of FIG. 2, this transistor is of type N and its electrode coupled to the second terminal of primary 104 corresponds to its drain. In the presence of a default in the circuit 1000, this transistor behaves like a current source (saturation state) but in the absence of a default, this transistor behaves like an on/off switch. For example, and according to the features of the transistor, the value of this current may be limited between approximately 150 mA and 200 mA for a voltage VGS in the order of 4 V, or be limited between approximately 450 mA and 500 mA for a voltage VGS in the order of 5 V.

In the example of FIG. 2, a DC voltage VCC is applied to the first terminal of primary 104. Thus, this voltage VCC is applied across primary 104 when control switch 124 is on. The on or off state of control switch 124 is controlled by a pulse control signal EN which, in the example of FIG. 2, is applied to the gate of the transistor forming control switch 124. Voltage VCC is thus applied to primary 104 at the frequency of the pulses of pulse control signal EN. For example, voltage VCC may be equal to 5 V, and the frequency of pulse control signal EN may be equal to 10 kHz.

In the example of FIG. 2, a second terminal of the first secondary 106 is coupled to one of the terminals of the second secondary 108. As a variant, it is possible for these terminals not to be coupled to each other.

In the example of FIG. 2, device 100 further comprises a first electric current limiting resistor 126 having an electrode coupled to the control input of precharge switch 1008. In FIG. 2, the other electrode of resistor 126 is coupled to the cathode of the voltage rectifier diode 114 and to one of the electrodes of power storage capacitor 116. The value of this first electric current limiting resistor 126 may be selected according to the value of the current sent to the control input of precharge switch 1008. As a variant, it is possible for device 100 not to comprise this resistor 126.

In the described example of embodiment, precharge switch 1008 comprises at least one thyristor and the control input of precharge switch 1008 corresponds to the gate of this thyristor. As a variant, other types of switches may be used to form precharge switch 1008, such as for example a TRIAC (triode for AC current), a relay, a transistor, etc.

Further, in the example of embodiment shown in FIG. 2, circuit 1000 also comprises a second electric current limiting resistor 1010 coupled in series to precharge switch 1008 (to the anode of the thyristor in the example of FIG. 2). This resistor 1010 is intended to limit the current circulating between source 1004 and bulk capacitor 1002, and thus to limit the precharge current of bulk capacitor 1002. For example, the value of the second electric current limiting resistor 1010 may be equal to 100 Ohms. Alternatively, the second electric current limiting resistor 1010 may be a PTC (Positive Temperature Coefficient) type thermistor.

In the first embodiment, circuit 1000 further comprises first and second cut-off switches 1012, 1014, each coupled between one of the terminals of source 1004 and one of the electrodes of bulk capacitor 1002. These first and second cut-off switches 1012, 1014 are intended to couple source 1004 to the bus of circuit 1000. To be able to ensure a physical cut-out between source 1004 and the bus of circuit 1000, at least one of the first and second cut-off switches 1012, 1014 comprises a relay, for example electromechanical. For example, the first and second cut-off switches 1012, 1014 may both correspond to relays, or one of the two cut-off switches 1012, 1014 may correspond to a relay and the other of the two cut-off switches 1012, 1014 may correspond to a semiconductor switch such as a transistor.

In the example of FIG. 2, the first cut-off switch 1012 is coupled in parallel with precharge switch 1008 and with resistor 1010. During the precharge of bulk capacitor 1002, the first cut-off switch 1012 is in the off or on state, and the second cut-off switch 1014 is in the on or off state.

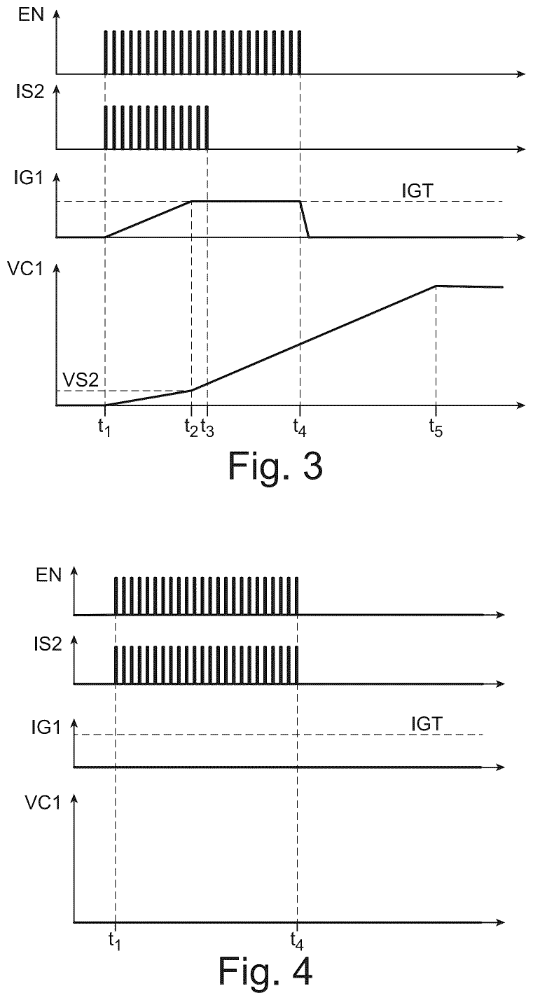

FIG. 3 shows a simplified example of a timing diagram of signals obtained within circuit 1000 according to the first previously-described embodiment, in the absence of a short-circuit of bulk capacitor 1002. In this drawing, the signals are schematically shown with amplitudes which are not to scale with respect to one another.

In FIG. 3, pulse control signal EN is applied to the control input of circuit 110 (corresponding to the gate of the transistor forming control switch 124 in the example of FIG. 2) between times t1 and t4. Due to the absence of a short-circuit of bulk capacitor 1002, the pulse voltage across primary 104 causes the generation of non-zero pulse voltages across the first and second secondaries 106, 108, which generate in turn the circulating of a pulse current IS2 from the second secondary 108 through bulk capacitor 1002 and an increase in the amplitude of a control current IGI sent to the control input of precharge switch 1008 (corresponding to the gate of the thyristor forming precharge switch 1008 in the example of FIG. 2).

In FIG. 3, time t2 corresponds to the time from which the thyristor forming precharge switch 1008 turns on, due to the fact that current IG1 reaches a value IGT triggering the turning-on of the thyristor. Between times t1 and t2, an increase in the voltage VC1 across bulk capacitor 1002 is due to the current issued by second secondary 108. From time t2, voltage VC1 more significantly increases due to the fact that precharge switch 1008 is in the on state and that source 1004 is coupled to bulk capacitor 1002 via resistor 1010 and precharge switch 1008. From time t3, as soon as the voltage VC1 exceeds the voltage supplied by the second secondary 108, current IS2 is null and the bulk capacitor 1002 charges to reach the VBat voltage value of the source 1004 at time t5. At the time t4 from which the control signal EN applied to the control input of control switch 124 is stopped because the thyristor forming the precharge switch 1008 is in the conducting state, current IGI drops down to zero. From time t5, bulk capacitor 1002 is precharged and source 1004 may be connected to the bus by turning on the first cut-off switch 1012 to limit losses due to the resistor 1010 during steady-state operation of the device 100.

FIG. 4 shows a simplified example of a timing diagram of signals obtained within the device 100 according to the previously-described first embodiment, in the presence of a short-circuit of bulk capacitor 1002. In this drawing, the signals are schematically shown with amplitudes which are not to scale with respect to one another.

As in FIG. 3, pulse control signal EN is applied to the control input of circuit 110 between times t1 and t4. Due to the short-circuit present across bulk capacitor 1002, the voltage across bulk capacitor 1002 remains equal to zero. The voltage across second secondary 108 is thus also equal to zero, which implies that the voltage across first secondary 106 then is also equal to zero. No control current is thus sent to the control input of precharge switch 1008, which thus remains in the off state.

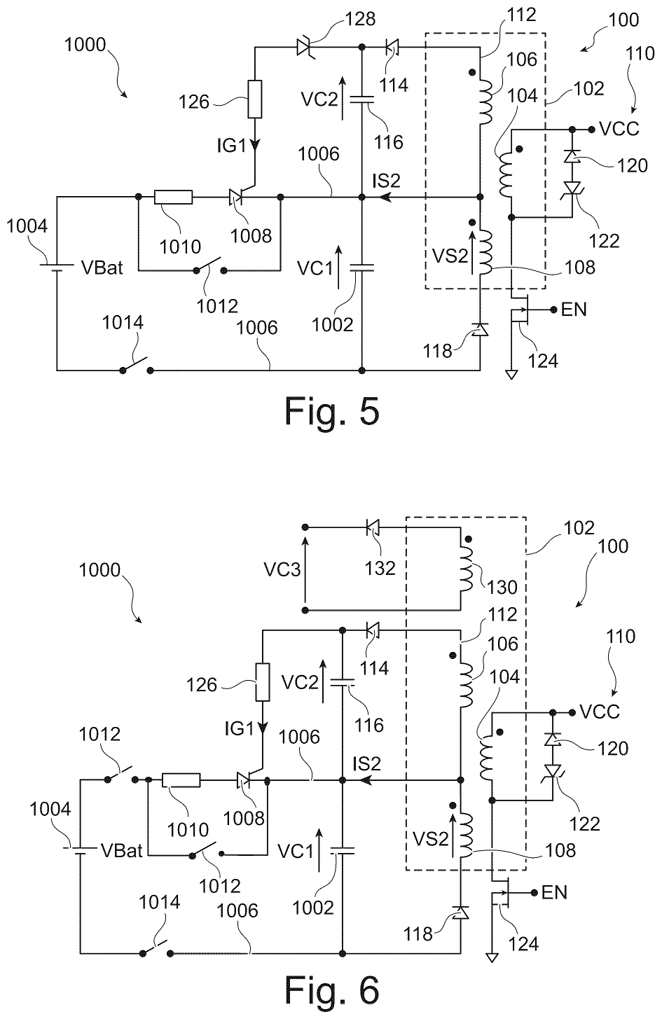

An example of the device 100 and of the circuit 1000 according to a first variant of the first embodiment is described hereafter in relation with FIG. 5.

In this first variant, device 100 and circuit 1000 comprise all the elements and components previously described in relation with FIG. 2. The device 100 according to this first variant further comprises a second Zener diode 128 having its cathode coupled to the cathode of the voltage rectifier diode 114 and to one of the electrodes of power storage capacitor 116, and having its anode coupled to the control input of precharge switch 1008, that is, the gate of the thyristor forming this precharge switch 1008 in the described example.

This first alternative embodiment may be advantageous in the presence of a short-circuit forming a load coupled in parallel with bulk capacitor 1002 and resulting in a high leakage from the circuit 1000, for example in the order of some ten Ohms or less. Indeed, in the presence of such a short-circuit and in the absence of the second Zener diode 128, non-zero voltages may be obtained across each of secondaries 106, 108 and across the voltage rectifier diode 114 when a voltage is applied across primary 104. In such a case, the amplitudes of the voltages obtained across secondaries 106, 108 particularly depend on the amplitude of the current circulating through the load formed by the short-circuit and on the ratio of the number of windings of secondaries 106, 108. A non-zero control current, for example of a few mA, may then be sent onto the control input of precharge switch 1008, which may trigger its setting to the on state and thus the precharge of bulk capacitor 1002. When device 100 comprises the second Zener diode 128, such a control current is blocked by the second Zener diode 128, thus preventing the setting to the on state of precharge switch 1008 and thus the precharge of bulk capacitor 1002, the threshold of the second Zener diode 128 depending on the short-circuit leakage current level.

The different configurations previously described in relation with FIG. 2 may apply to this first variant of the first embodiment.

An example of the device 100 and of the circuit 1000 according to a second variant of the first embodiment is described hereafter in relation with FIG. 6.

In this second variant, device 100 and circuit 1000 comprise all the elements and components previously described in relation with FIG. 2, with however the transformer 102 which comprises at least one third secondary 130 having its terminals configured to be coupled to a voltage measurement device (not shown in FIG. 6) for example corresponding to a microcontroller. In the example of FIG. 6, a second voltage rectifier diode 132 is coupled to one of the terminals of the third secondary 130 and blocks the voltage of the third secondary 130 when it is negative, thus enabling the voltage-measuring device to measure only a positive voltage.

This second variant may have the advantage of allowing a measurement of the voltage of one of the secondaries of transformer 102, in isolated manner and without having to connect a voltage measurement device to the first and second secondaries 106, 108. In a specific configuration, the third secondary 130 may have a number of windings similar to that of the first secondary 106, which enables to have across the third secondary 130 a voltage with a value similar to that obtained across the first secondary 106. A measurement of a zero (or very low) voltage across third secondary 130 may thus mean that a short-circuit is present in circuit 1000, in particular across bulk capacitor 1002.

The different configurations previously described in relation with FIG. 2 may apply to this second variant of the first embodiment. Further, the first and second alternative embodiments described hereabove may be combined with each other, device 100 comprising in this case the second Zener diode 128 and a pulse transformer 102 comprising at least three secondaries 106, 108, and 130.

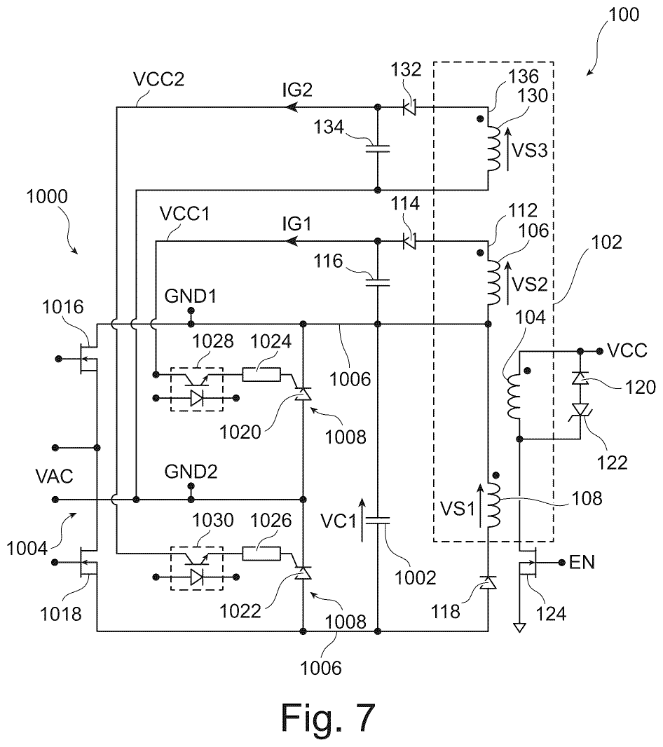

An example of the device 100 and of the circuit 1000 according to a second embodiment is described hereafter in relation with FIG. 7. In this second embodiment, circuit 1000 may form part of or form a power converter.

In this second embodiment, source 1004 comprises an AC/DC voltage converter (the AC input voltage is called VAC in FIG. 7) of totem pole type comprising at least one first branch comprising two conversion transistors 1016, 1018, for example MOS type, and at least one second branch comprising two conversion thyristors 1020, 1022. The gates of the two thyristors 1020, 1022 each are coupled to an electric current limiting resistor 1024, 1026 and an optocoupler 1028, 1030 series-coupled to each other. In the described example of embodiment, each assembly comprising one of thyristors 1020, 1022, one of resistors 1024, 1026, and one of optocouplers 1028, 1030 forms a precharge switch 1008 configured to be on during the precharge of bulk capacitor 1002.

Alternatively, transistors 1016 and 1018 may be of the IGBT (insulated gate bipolar transistor) type.

In this second embodiment, transformer 102 comprises, in addition to the first and second secondaries 106, 108, a third secondary 130 having a first terminal 136 coupled to the second voltage rectifier diode 132. In the described example, device 100 further comprises a second power storage capacitor 134 coupled in parallel with third secondary 130. In the example of FIG. 1, the first terminal 136 of the third secondary 130 is coupled to one of the electrodes of the second power storage capacitor 134 via the second voltage rectifier diode 132, the second power storage capacitor 134 being here coupled in parallel with the assembly formed by the third secondary 130 and the second voltage rectifier diode 132. In the example of FIG. 7, the cathode of the second voltage rectifier diode 132 is coupled to one of the electrodes of the second power storage capacitor 134 and the anode of the second voltage rectifier diode 132 is coupled to the first terminal 136 of the third secondary 130.

The first terminal 112 of the first secondary 106 is coupled, via the first voltage rectifier diode 114, to the control input of one of precharge switches 1008 formed by an input electrode of optocoupler 1028, and the first terminal 136 of the third secondary 130 is coupled, via the second voltage rectifier diode 132, to the control input of the other one of the precharge switches 1008 formed by an input electrode of optocoupler 1030.

The operation of the device 100 and of the circuit 1000 according to the second embodiment is substantially similar to that previously described for the device 100 and the circuit 1000 according to the first embodiment. In the presence of a short-circuit of bulk capacitor 1002, the voltages across each of secondaries 106, 108, 130 are equal to zero, and no control current is sent to the input electrode of optocouplers 1028, 1030. In the absence of a short-circuit of bulk capacitor 1002, the voltages across each of secondaries 106, 108, 130 are non-zero, and non-zero control currents are then sent to the input electrodes of optocouplers 1028, 1030, thus triggering the turning-on of thyristors 1020, 1022 via current flowing through the gates of the thyristors 1020, 1022, and the precharge of bulk capacitor 1002.

As a variant of this second embodiment, device 100 may comprise, as in the previously-described first variant of the first embodiment, Zener diodes having their cathode coupled to the cathode of the voltage rectifier diodes 114, 132 and having its anode coupled to the input electrode of each of optocouplers 1028, 1030. It is also possible for pulse transformer 102 to comprise, as in the previously-described second variant of the first embodiment, a fourth secondary having its terminals configured to be coupled to a voltage measurement device.

The different configurations previously described in relation with the first embodiment may apply to the device 100 and to the circuit 1000 according to the second embodiment.

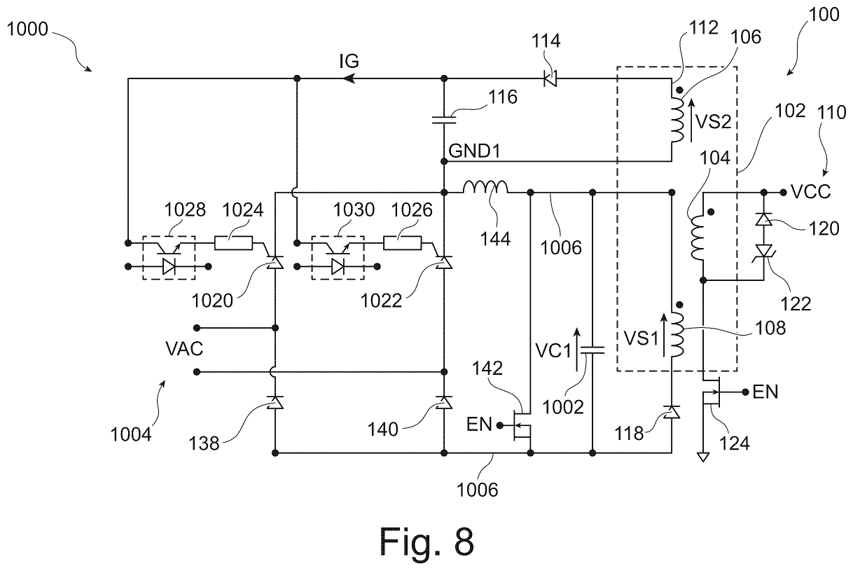

An example of the device 100 and of the circuit 1000 according to a third embodiment is described hereafter in relation with FIG. 8. In this third embodiment, circuit 1000 may form part of or form a power converter.

In this third embodiment, source 1004 comprises an AC/DC voltage converter of Boost PFC (“Power Factor Correction”) type with a mixed bridge comprising at least two conversion diodes 138, 140 and two conversion thyristors 1020, 1022. The gates of the two thyristors 1020, 1022 are each coupled to an electric current limiting resistor 1024, 1026 and an optocoupler 1028, 1030 series-coupled to each other. As in the previously-described second embodiment, each assembly comprising one of thyristors 1020, 1022, one of resistors 1024, 1026, and one of optocouplers 1028, 1030 forms a precharge switch 1008 configured to be on during the precharge of bulk capacitor 1002.

As a variant, it is possible to replace the conversion diodes 138, 140 by thyristors.

The first terminal 112 of the first secondary 106 is coupled, via the voltage rectifier diode 114, to the control input of precharge switches 1008 formed by an input electrode of each of optocouplers 1028, 1030. Thus, the current issued by the first secondary 106 is intended to form the control current of precharge switch 1008.

In the example of FIG. 8, circuit 1000 further comprises a transistor 142 of MOSFET type, for example similar to the transistor 124 of circuit 110. Pulse control signal EN is applied to the gate of this transistor 142. The source and drain electrodes of this transistor 142 are coupled to the electrodes of bulk capacitor 1002 in such a way that transistor 142 is coupled in parallel with bulk capacitor 1002. Further, an inductance 144 is coupled to one of the electrodes of bulk capacitor 1002.

When the transistor 142 is conductive, current flows through the inductance 144, which accumulates energy. When transistor 142 is off, the energy stored in the inductance 144 is sent to the bulk capacitor 1002. The transistor 142 can be controlled in such a way that the supplied current is sinusoidal and in phase with the supplied voltage, by means of regulation via the transistor 142.

The operation of the device 100 and of the circuit 1000 according to the third embodiment is substantially similar to that previously described for the device 100 and the circuit 1000 according to the first and second embodiments. In the presence of a short-circuit of bulk capacitor 1002, the voltages across each of secondaries 106, 108 are equal to zero, and no control current is sent to the input electrodes of optocouplers 1028, 1030. In the absence of a short-circuit of bulk capacitor 1002, the voltages across each of secondaries 106, 108 are non-zero, and a non-zero control current is then sent to the input electrodes of optocouplers 1028, 1030, thus triggering the setting to the on state of thyristors 1020, 1022 via current flowing through the gates of the thyristors 1020, 1022 and the precharge of bulk capacitor 1002.

As a variant of this third embodiment, device 100 may comprise, as in the first previously-described variant of the first embodiment, a Zener diode having its cathode coupled to the cathode of the voltage rectifier diode 114 and having its anode coupled to the input electrode of each of optocouplers 1028, 1030. It is also possible for pulse transformer 102 to comprise, as in the previously-described second variant of the first embodiment, a fourth secondary having its terminals configured to be coupled to a voltage measurement device.

The different configurations previously described in relation with the first and second embodiments may apply to the device 100 and to the circuit 1000 according to the third embodiment.

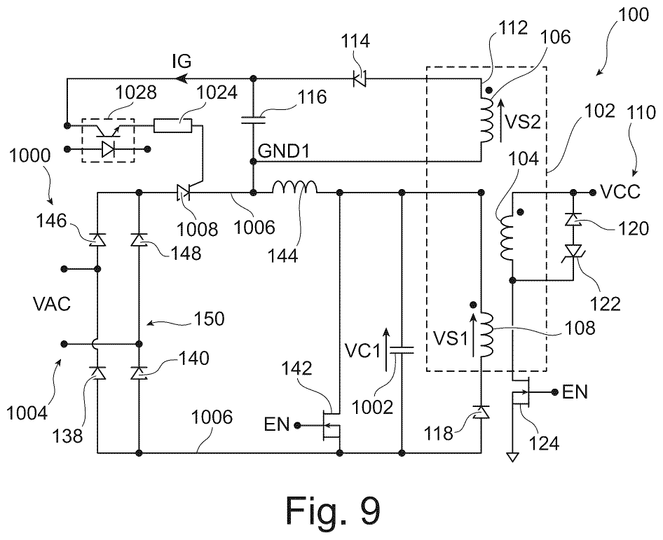

An example of the device 100 and of the circuit 1000 according to a fourth embodiment is described hereafter in relation with FIG. 9. In this fourth embodiment, circuit 1000 may form part of or form a power converter.

In this fourth embodiment, source 1004 comprises an AC/DC voltage converter of Boost PFC type comprising at least a diode bridge 150 (in FIG. 9, four conversion diodes forming diode bridge 150 bear reference numerals 138, 140, 146, and 148).

In this fourth embodiment, precharge switch 1008, configured to be on during the precharge of bulk capacitor 1002, comprises a thyristor having its gate, forming the control input of precharge switch 1008, coupled to a current limiting resistor 1024 and an optocoupler 1028.

The other elements of device 100 and of circuit 1000 are similar to those previously described in relation with the third embodiment.

The operation of the device 100 and of the circuit 1000 according to this fourth embodiment is substantially similar to that previously described for the device 100 and the circuit 1000 according to the previous embodiments. In the presence of a short-circuit of bulk capacitor 1002, the voltages across each of secondaries 106, 108 are equal to zero, and no control current is sent to the input electrode of optocoupler 1028. In the absence of a short-circuit of bulk capacitor 1002, the voltages across each of secondaries 106, 108 are non-zero, and a non-zero control current is then sent to the input electrode of optocoupler 1028, thus triggering the setting to the on state of the thyristor forming charge switch 1008 via current flowing through its gate and the precharge of bulk capacitor 1002.

In all modes, examples, and alternative embodiments, the thyristor(s), or SCRs (“Silicon Controlled Rectifier”), used to form the charge switch(es) 1008 may be replaced with other types of switches, such as for example TRIACs, relays, or transistors.

In the second, third, and fourth previously-described embodiments, source 1004 comprises an AC/DC converter. As a variant, it is possible for source 1004 to comprise a DC/DC converter, or a transformer such as a Flyback converter.

As a variant of the example of embodiment of the precharge control circuit 110 previously described in the different embodiments, it is possible for circuit 110 to comprise a microcontroller and/or a DSP (digital signal processor) to control the primary 104 of pulse transformer 102.

The values of the different previously-described elements may be different from the previously-mentioned examples, these values being a function, in particular, of the applications and of the operating environment of device 100 and of circuit 1000.

Device 100 enables to improve the protection of DC current circuit 1000 by using a pulse transformer 102 to detect, due to one of the secondaries of transformer 102, a possible fault in circuit 1000 such as a short-circuit of bulk capacitor 1002, and to allow or not, after the detection or not of a fault and due to the other secondary or secondaries of transformer 102, the precharge of bulk capacitor 1002. The short-circuit detection and precharge control functions are thus implemented at the same time, from a same pulse transformer.

For example, when a thyristor is used as a precharge switch, device 100 can for example avoid a turning-on of the thyristor in the presence of a short-circuit of bulk capacitor 1002 or of a fault such as a leakage in circuit 1000. When a relay is used as a precharge switch, device 100 enables to perform a short-circuit or fault detection in circuit 1000 without having to close the relay to perform this detection.

Device 100 allows a rapid detection of a short-circuit or leakage fault in DC current circuit 1000. Further, device 100 requires no circuit only dedicated to the turning off of the precharge switch.

Device 100 may be used in particular in battery management systems (or BMS), electric vehicles, or also in power conversion structures for example of totem pole type, mixed bridges, etc.

The device is for example intended for the automobile industry. The electrification of automobile vehicles generates a higher and higher electronic content level in vehicles. The device for example comprises thyristors, rectifiers, high-voltage transient voltage suppression diodes, modules, etc. intended to be incorporated in such vehicles. The automation of driving also generates more and more electronic content in vehicles. The device for example comprises high-voltage transient voltage suppression diodes, an electromagnetic discharge protection, and common-mode filters for protection against electric risks in emerging complex electronics.

The device may for example be used in the industrial field. More particularly, the device for example aims at being used for the development of green energy or for the electrification of infrastructures, for example for charge terminals or for the incorporation of solar energy. The device is for example intended to be implemented in power and energy circuits of equipment, for example comprising 800-V or 1200-V thyristors, ultrafast and silicon carbide 1200-V diodes, transient voltage suppression diodes, and electromagnetic discharge protections. The device may also be used in the implementation of datacenters and of servers. The device for example comprises wide bandgap materials.

The device is for example intended to be used in communication equipment, or in computers and peripherals. For example, the device may be used in 5G infrastructures and dedicated datacenters. The device for example comprises silicon carbide diodes, Schottky power transistors, electromagnetic discharge protections, and transient voltage suppression diodes. The device may also be used in satellites, for example comprising integrated passive devices for radio frequency applications.

The device may be used for any type of AC/DC or DC/DC converter.

The solution described can be used to control any type of precharge switch: thyristor, MOSFET, relay, IGBT, etc.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. A device for controlling a precharge of a bulk capacitor and for detecting faults in a DC current circuit which comprises the bulk capacitor, at least one DC voltage source, and at least a first precharge switch coupled to an electrode of the bulk capacitor, the device comprising:
a pulse transformer provided with a primary and with at least a first secondary and a second secondary; and
a circuit for controlling the precharge of the bulk capacitor, coupled to the primary of the pulse transformer;
wherein the first secondary of the pulse transformer comprises a first terminal configured to be coupled to a control input of the first precharge switch; and
wherein the second secondary of the pulse transformer is configured to be coupled in parallel with the bulk capacitor.

2. The device according to claim 1, further comprising at least a first power storage capacitor coupled in parallel with the first secondary of the pulse transformer.

3. The device according to claim 1, further comprising at least a first voltage rectifier diode having its anode coupled to the first terminal of the first secondary of the pulse transformer, and/or at least a first electric current limiting resistor having an electrode configured to be coupled to the control input of the first precharge switch.

4. The device according to claim 3, further comprising at least a second Zener diode having its cathode coupled to the cathode of the first voltage rectifier diode and having its anode configured to be coupled to the control input of the first precharge switch.

5. The device according to claim 1, further comprising at least a second protection diode coupled in series with the second secondary of the pulse transformer.

6. The device according to claim 1, wherein the circuit for controlling the precharge of the bulk capacitor comprises at least:
a third diode having its cathode coupled to a first terminal of the primary of the pulse transformer;
a first Zener diode having its anode coupled to the anode of the third diode and having its cathode coupled to a second terminal of the primary of the pulse transformer; and
a control switch coupled to the second terminal of the primary of the pulse transformer.

7. The device according to claim 1, wherein a second terminal of the first secondary of the pulse transformer is coupled to one of one or more terminals of the second secondary of the pulse transformer.

8. The device according to claim 1, wherein the pulse transformer comprises at least a third secondary having its terminals configured to be coupled to a voltage measurement device or to a control input of a second precharge switch.

9. A DC current circuit comprising:
a DC voltage source;
a bus comprising at least two conductive elements, each coupled to one of the one or more terminals of the DC voltage source;
a capacitive element forming a bulk capacitor having each of its electrodes coupled to one of the two conductive elements of the bus;
a first precharge switch coupled to an electrode of the bulk capacitor; and
a device for controlling a precharge of the bulk capacitor and for detecting faults in the DC current circuit comprising:
a pulse transformer provided with a primary and with at least a first secondary and a second secondary; and
a circuit for controlling the precharge of the bulk capacitor, coupled to the primary of the pulse transformer;
wherein the first secondary of the pulse transformer comprises a first terminal configured to be coupled to a control input of the first precharge switch; and
wherein the second secondary of the pulse transformer is configured to be coupled in parallel with the bulk capacitor.

10. The DC current circuit according to claim 9, wherein the DC voltage source comprises at least a battery.

11. The DC current circuit according to claim 10, wherein the first precharge switch comprises at least a first thyristor and the control input of the first precharge switch corresponds to a gate of the first thyristor, and further comprising:
a second electric current limiting resistor series-coupled to the first thyristor; and
first and second cut-off switches, each coupled between one of the one or more terminals of the DC voltage source and one of the electrodes of the bulk capacitor, at least one of the first and second cut-off switches comprising a relay.

12. The DC current circuit according to claim 11, wherein one of the first and second cut-off switches is coupled in parallel with the first thyristor and with the second electric current limiting resistor.

13. The DC current circuit according to claim 9, wherein the DC voltage source comprises an AC/DC voltage converter of totem pole type comprising at least two conversion transistors and at least two conversion thyristors having their gates each coupled to a third electric current limiting resistor and an optocoupler series-coupled to each other and forming first and second precharge switches;
wherein the pulse transformer of the device comprises at least a third secondary;
wherein the first terminal of the first secondary of the pulse transformer of the device is coupled to an input electrode of one of the optocouplers; and
wherein a first terminal of the third secondary of the pulse transformer of the device is coupled to an input electrode of the other one of the optocouplers.

14. The DC current circuit according to claim 9, wherein the DC voltage source comprises an AC/DC voltage converter of Boost PFC type with a mixed bridge comprising at least two conversion diodes and at least two conversion thyristors, or at least four conversion thyristors, having their gates each coupled to a third electric current limiting resistor and an optocoupler series-coupled to each other and forming first and second precharge switches; and
wherein the first terminal of the first secondary of the pulse transformer of the device is coupled to an input electrode of each of the optocouplers.

15. The DC current circuit according to claim 9, wherein the DC voltage source comprises an AC/DC voltage converter of Boost PFC type with a diode bridge; and
wherein the first precharge switch comprises at least a first thyristor, a third electric current limiting resistor, and an optocoupler series-coupled to each other.
